(19) United States
(12) Patent Application Publication
(10) Pub. No.: US 2007/0119057 A1
(43) Pub. Date: May 31, 2007

(54) High-branch shears

(76) Inventor: Pao-Lu Chen, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/286,337

(22) Filed: Nov. 25, 2005

(51) Int. Cl. B26B 13/00

(52) U.S. Cl. 30/249

(57) ABSTRACT

A high-branch shears including a branch-shearing mechanism connected with one end of a connecting rod a pulley device composed of an adjustment unit, a movable pulley and a cord passed through and wound on the adjustment unit and the movable pulley. The movable pulley is pivotally mounted on a pulley rack which is pivotally connected with the branch-shearing mechanism. The adjustment unit includes a first fixed pulley, a movable member, a fixed seat and a locating member. The movable member is slidably fitted on the connecting rod. The first fixed pulley is pivotally mounted on the movable member. The fixed seat is fixed on the branch-shearing mechanism or the connecting rod. The locating member is disposed between the movable member and the fixed seat for adjustably fixing a distance between the movable member and the fixed seat. One end of the cord is fixed on the pulley rack. The cord is sequentially passed through and wound on the first fixed pulley and the movable pulley. The other end of the cord is a force application end for a user to pull to drive the branch-shearing mechanism for shearing branches.

### BACKGROUND OF THE INVENTION

The present invention is related to an improved high-branch shears in which an adjustment unit is fixed on the branch-shearing mechanism or the connecting rod. The high-branch shears includes a locating member for adjusting a distance between a movable member and a fixed seat. The high-branch shears can be operated to shear branches with less strength.

FIG. 10 shows a conventional high-branch shears having a connecting rod 61 and a shear seat 62 connected with one end of the connecting rod 61. The shear seat 62 has a shear opening 621. A shear board 63 is pivotally mounted on the shear seat 62. The shear board 63 has a blade section 631 corresponding to the shear opening 621 of the shear seat 62. A rocking arm 64 is pivotally connected with the shear seat 62. One end of the shear board 63 distal from the. blade section 631 is pivotally connected with the rocking arm 64. A restoring spring 65 is connected between the rocking arm 64 and the shear seat 62. A movable pulley 66 is pivotally connected with one end of the rocking arm 64 distal from the shear seat 62. An adjustment unit 67 is pivotally disposed at one end of the shear seat 62 distal from the rocking arm 64. A cord 68 is passed through the movable pulley 66 and the adjustment unit 67. By means of pulling the cord 68, the rocking arm 64 is swung to drive the shear board 63. The shear board 63 is pivoted, whereby the blade section 631 is moved relative to the shear opening 621 for shearing branches.

The adjustment unit 67 is pivotally disposed at the end of the shear seat 62 distal from the rocking arm 64. When the rocking arm 64 is swung to shear the branches, the angle θ contained between the cord 68 between the fixed pulley 67 and the movable pulley 66 and the vertical line is several times enlarged as shown in FIG. 11. Under such circumstance, the component force Fa for downward pulling the pulley 66 is minified. In other words, the larger the amplitude of the downward swinging rocking arm 64 is, the larger the angle θ is and the less the component force for downward pulling the pulley 66 is. As a result, it is necessary to apply a greater downward pulling force to the cord 68. This makes it laborious to shear the branches.

### SUMMARY OF THE INVENTION

It is therefore a primary object of the present invention to provide a high-branch shears in which a locating member is disposed between a movable member and a fixed seat of an adjustment unit for adjustably fixing a distance between the movable member and the fixed seat. The movable member is slidably fitted on the connecting rod. The fixed seat is fixed on the branch-shearing mechanism or the connecting rod. When it is necessary to adjust the shears for shearing branches with different diameters, by means of the locating member, the distance between the movable member and the fixed seat can be quickly and conveniently adjusted.

According to the above object, the high-branch shears of the present invention includes:

a branch-shearing mechanism connected with one end of a connecting rod for shearing branches; and

a pulley device composed of an adjustment unit, a movable pulley and a cord passed through and wound on the adjustment unit and the movable pulley, the movable pulley being pivotally mounted on a pulley rack which is pivotally connected with the branch-shearing mechanism, the adjustment unit including a first fixed pulley, a movable member, a fixed seat and a locating member, the movable member being slidably fitted on the connecting rod, the first fixed pulley being pivotally mounted on the movable member, the movable member being movable relative to the fixed seat, the fixed seat being fixed on the branch-shearing mechanism or the connecting rod, the locating member being disposed between the movable member and the fixed seat for adjustably fixing a distance between the movable member and the fixed seat, one end of the cord being fixed on the pulley rack, the cord being sequentially passed through and wound on the first fixed pulley and the movable pulley, the other end of the cord being a force application end for a user to pull to drive the branch-shearing mechanism for shearing branches.

The present invention can be best understood through the following description and accompanying drawings wherein:

### BRIEF DESCRIPTION OF THE DRAWINGS

FIG. 1 is a side view of the present invention;

FIG. 2 is a perspective view of the adjustment unit of the present invention;

FIG. 3 is a plane sectional view of the adjustment unit of the present invention;

FIG. 4 is a sectional view taken along line 3-3 of FIG. 3;

FIG. 5 shows the use of the present invention;

FIG. 6-1 shows that the locating bolt of the present invention is-pressed with a finger;

FIG. 6-2 shows that the locating bar of the present invention is moved upward;

FIG. 6-3 shows that the locating bolt of the present invention is released;

FIG. 7 is a perspective view of the locating member of a second embodiment of the present invention;

FIG. 8-1 shows that the locating bar of the second embodiment of the present invention is not biased;

FIG. 8-2 shows that the locating bar of the second embodiment of the present invention is outward biased to make the locating bolt move out of the notch;

FIG. 8-3 shows that the locating bar of the second embodiment of the present invention is shifted to make the locating bolt move into another notch;

FIG. 9 is a side view of a third embodiment of the present invention;

FIG. 10 is a side view of a conventional high-branch shears; and

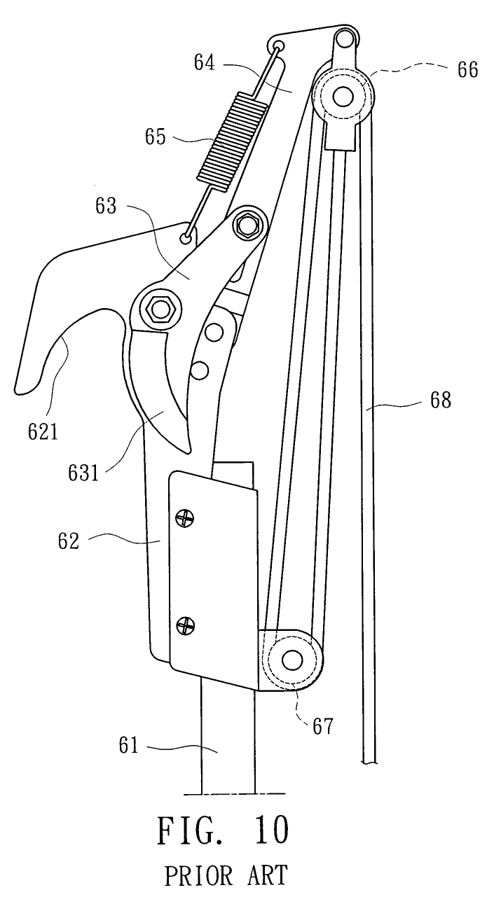

FIG. 11 shows the use of the conventional high-branch shears.

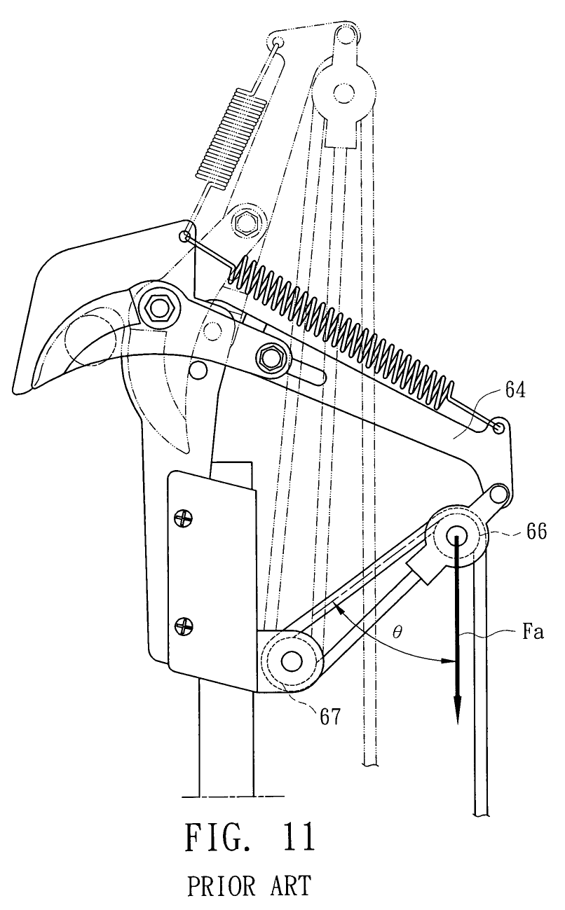

### DETAILED DESCRIPTION OF THE PREFERRED EMBODIMENTS

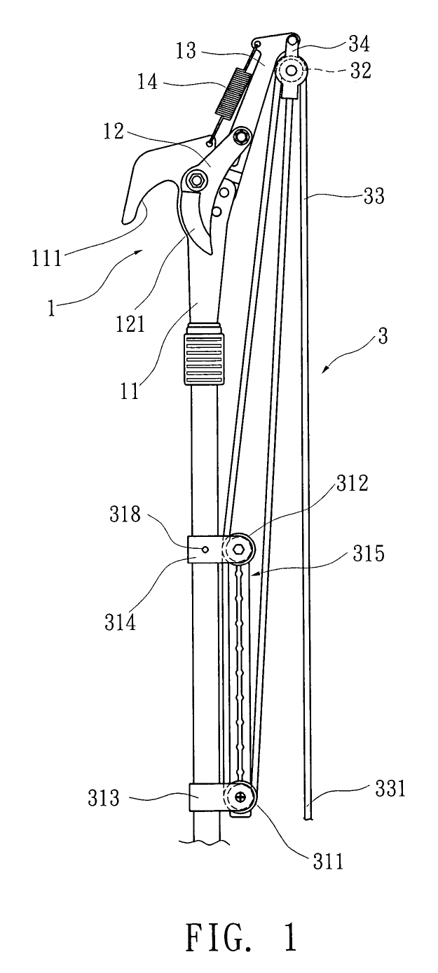

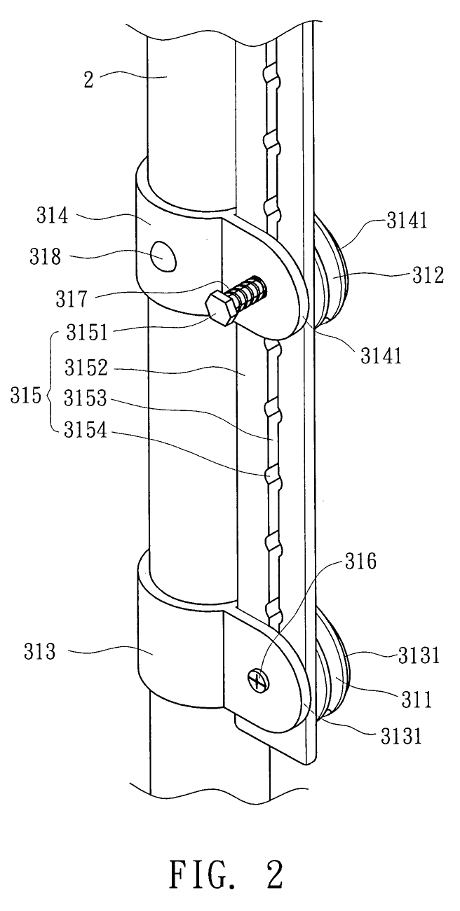

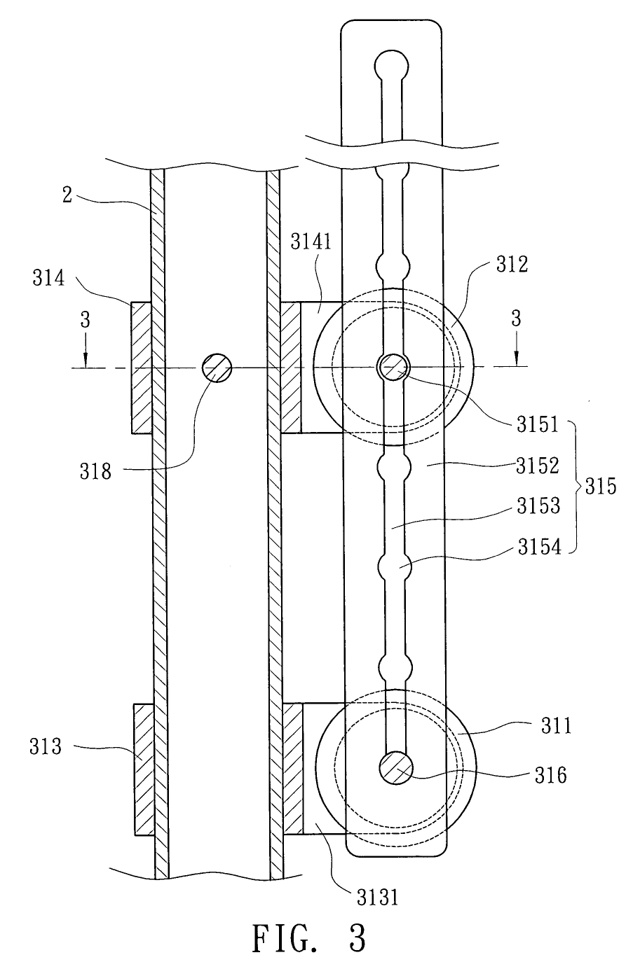

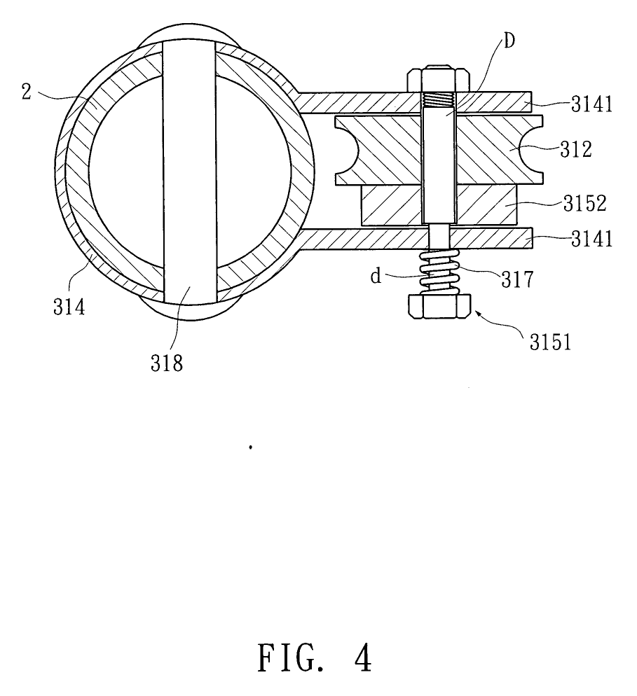

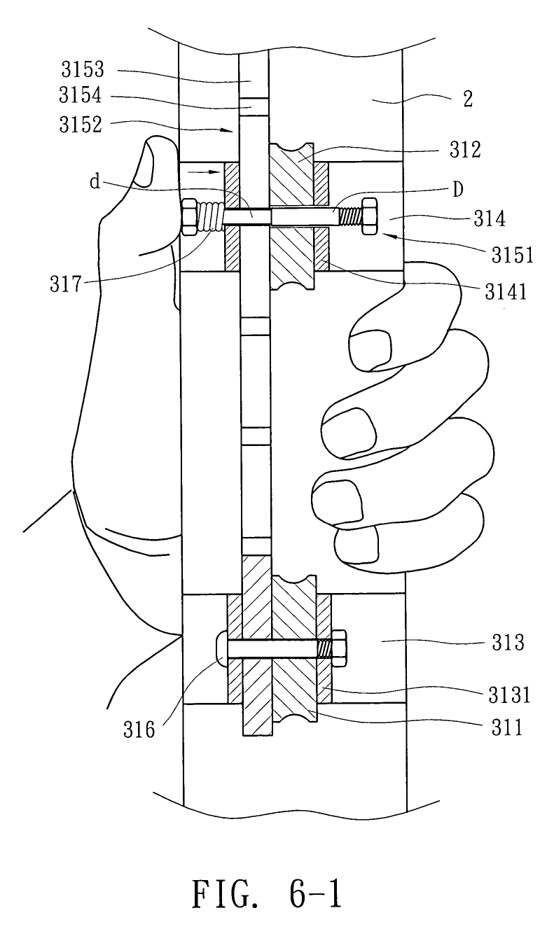

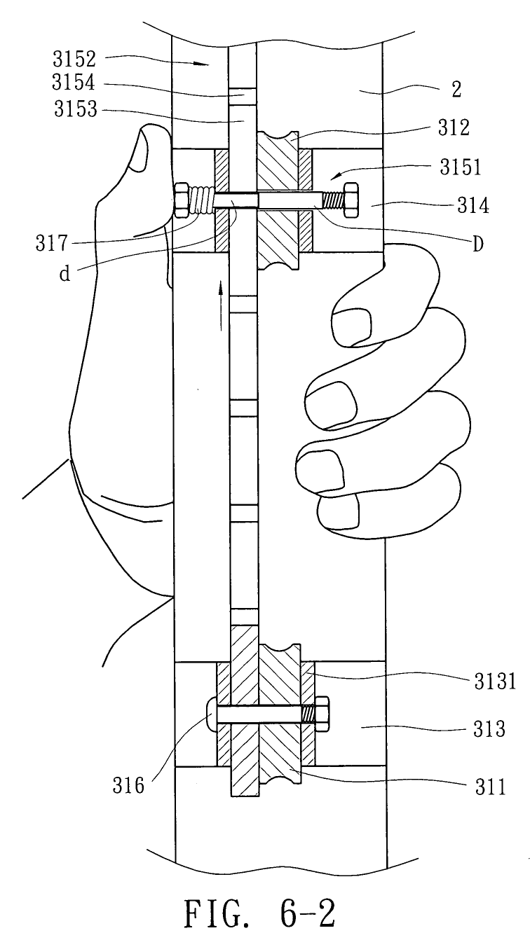

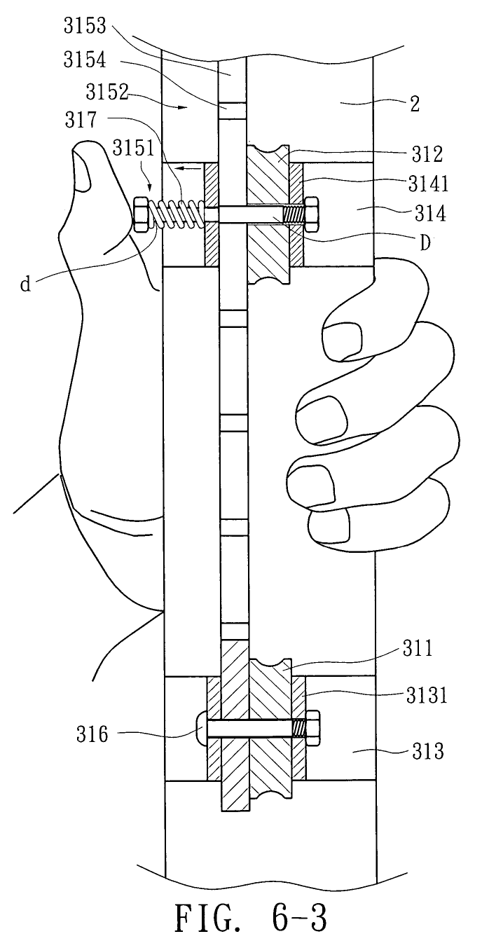

Please refer to FIGS. 1 to 7. The high-branch shears of the present invention includes a branch-shearing mechanism 1 connected with one end of a connecting rod 2. The branch-shearing mechanism 1 is drivable by a pulley device 3 for shearing branches. The branch-shearing mechanism 1 includes a shear seat 11 connected with the connecting rod 2. The shear seat 11 has a shear opening 111 facing downward.

The branch-shearing mechanism 1 further includes a shear board 12 pivotally disposed on the shear seat 11. The shear board 12 has a blade section 121 corresponding to the shear opening 111 of the shear seat 11.

The branch-shearing mechanism 1 further includes a rocking arm 13 pivotally disposed on the shear seat 11. One end of the shear board 12 distal from the blade section 121 is pivotally connected with the rocking arm 13. A restoring spring 14 is connected between the rocking arm 13 and the shear seat 11. The pulley device 3 is pivotally connected with one end of the rocking arm 13 distal from the shear seat 11. When the pulley device 3 drives the rocking arm 13 to swing, the shear board 12 is driven and pivoted, whereby the blade section 121 is moved relative to the shear opening 111 for shearing branches.

The pulley device 3 is composed of an adjustment unit 31, a movable pulley 32 and a cord 33 passed through and wound on the adjustment unit 31 and the movable pulley 32. The movable pulley 32 is pivotally mounted on a pulley rack 34 which is pivotally connected with one end of the rocking arm 13 distal from the shear seat 11. The adjustment unit 31 includes a first fixed pulley 311, a second fixed pulley 312, a movable member 313, a fixed seat 314 and a locating member 315. The movable member 313 is slidably fitted on the connecting rod 2. The first fixed pulley 311 is pivotally mounted on the movable member 313. The movable member 313 is movable relative to the fixed seat 314. The fixed seat 314 is fixed on the shear seat 11 of the branch-shearing mechanism 1 or the connecting rod 2.

In this embodiment, the fixed seat 314 is fixed on the connecting rod 2 distal from the branch-shearing mechanism 1. One end of the cord 33 is fixed on the pulley rack 34. The cord 33 is sequentially passed through and wound on the first fixed pulley 311, the second fixed pulley 312 and the movable pulley 32. The other end of the cord 33 is a force application end 331 for a user to pull to drive the branch-shearing mechanism 1 for shearing branches.

The movable member 313 is a substantially ring-shaped member fitted around the connecting rod 2. The movable member 313 has two first lugs 3131. A pin member 316 is connected between the first lugs 3131. The first fixed pulley 311 is pivoted on the pin member 316. One end of the locating member 315 is fixed with the pin member 316. The fixed seat 314 is a substantially ring-shaped member fixedly fitted around the connecting rod 2 near the branch-shearing mechanism 1. The fixed seat 314 has two second lugs 3141. The second fixed pulley 312 is pivotally disposed between the second lugs 3141. The other end of the locating member 315 is positioned between the second lugs 3141.

The locating member 315 includes a locating bolt 3151 and a locating bar 3152. The locating bolt 3151 has a small diameter section d and a large diameter section D. The locating bolt 3151 is-fitted through the second lugs 3141. A first end of the locating bolt 3151 outward protrudes from one of the second lugs 3141. A resilient member 317 is disposed between the first end of the locating bolt and the second lug 3141 adjacent to the first end of the locating bolt. In this embodiment, the resilient member is a compression spring. The small diameter section d of the locating bolt 3151 extends from the first end of the locating bolt 3151 to one side of the locating bar 3152 proximal to the compression spring. The large diameter section D extends from the small diameter section d to a second end of the locating bolt 3151. The locating bar 3152 is formed with a slot 3153 for the small diameter section d of the locating bolt 3151 to extend through. The slot 3153 has several locating holes 3154 for the large diameter section D of the locating bolt 3151 to pass therethrough. The large diameter section D can extend through any of the locating holes 3154 of the locating bar 3152. A fixing pin 318 is radially passed through the fixed seat 314 and the connecting rod 2 to fix the fixed seat 314 on the connecting rod 2.

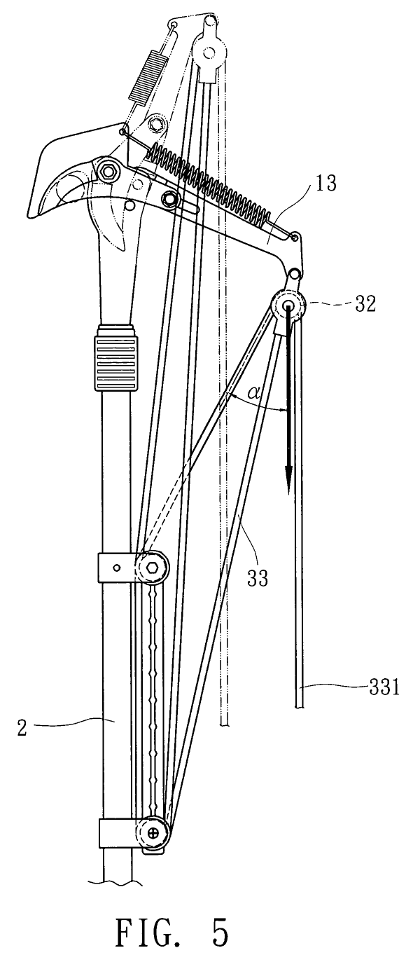

Referring to FIG. 5, the second fixed pulley 312 is pivotally mounted on the fixed seat 314 and the first fixed pulley 311 is pivotally mounted on the movable member 313. The locating member 315 is arranged between the movable member 313 and the fixed seat 314. When a user pulls the force application end 331 of the cord 33 downward to drive and pivot the rocking arm 13 downward, the angle α contained between the cord 33 between the first fixed pulley 311 and the movable pulley 32 and the vertical line is enlarged to a less extent. That is, the component force for downward pulling the movable pulley 32 is minified to a less extent. Therefore, the force applied to the cord 33 is increased to a less extent. Accordingly, the shears can be operated with less strength.

Referring to FIGS. 6-1 to 6-3, when it is necessary to adjust the shears for shearing branches with different diameters, a user can press the protruding first end of the locating bolt with a finger to compress the compression spring. At this time, the large diameter section D of the locating bolt 3151 is extracted from the locating hole 3154 and the small diameter section d of the locating bolt is longitudinally movably positioned in the slot 3153. The movable member 313 is moved along with the locating bar 3152. When moved through a certain distance, the locating bolt is released. At this time, the compression spring is restored to make the large diameter section D extend into a new locating hole 3154. Under such circumstance, the movable member 313 is spaced from the fixed seat 314 by a new distance and located. According to the above arrangement, by means of the locating bolt 3151 and the locating bar 3152 of the adjustment unit 31, the distance between the movable member 313 and the fixed seat 314 can be quickly and conveniently adjusted for shearing branches with different diameters.

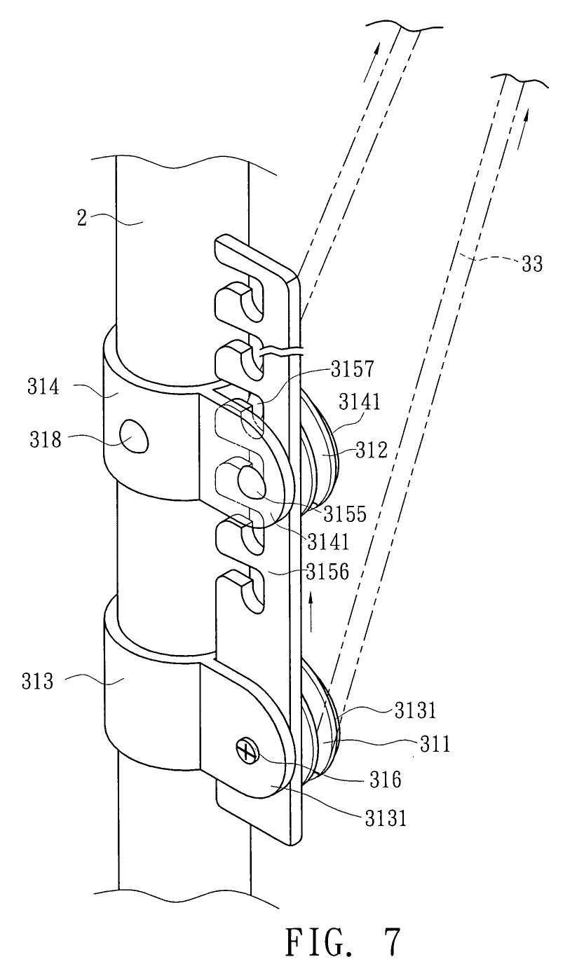

FIG. 7 shows a second embodiment of the present invention, in which the locating member 315 includes a locating bolt 3155 and a locating bar 3156. One side of the locating bar 3156 is formed with several substantially L-shaped notches 3157 facing the connecting rod 2. The locating bolt 3155 can be inlaid and located in any of the notches 3157. When the cord 33 is free from any application force, the locating bar 3156 will move downward due to gravity. Under such circumstance, the locating bolt 3155 will abut against top wall of the notch 3157. When a force is applied to the cord 33 for shearing branches, the locating bar 3156 is driven to move upward. At this time, the locating bolt 3155 abuts against bottom wall of the notch 3157 and is inlaid and located in the notch 3157.

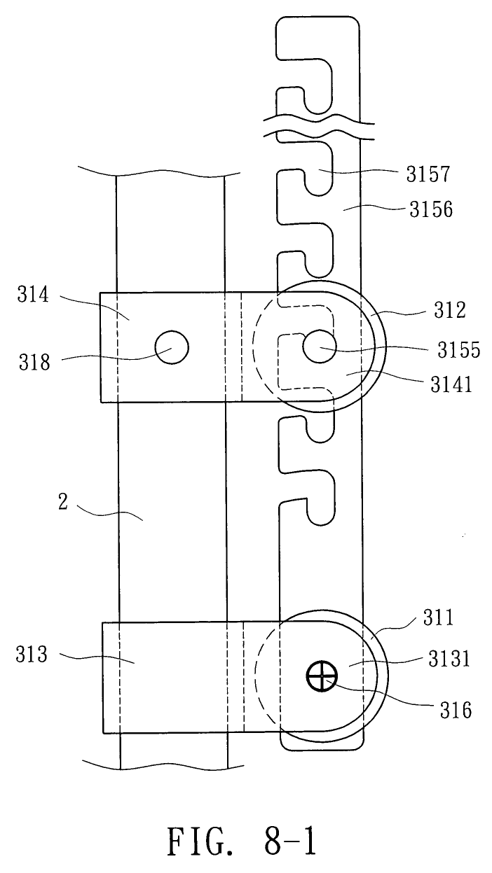

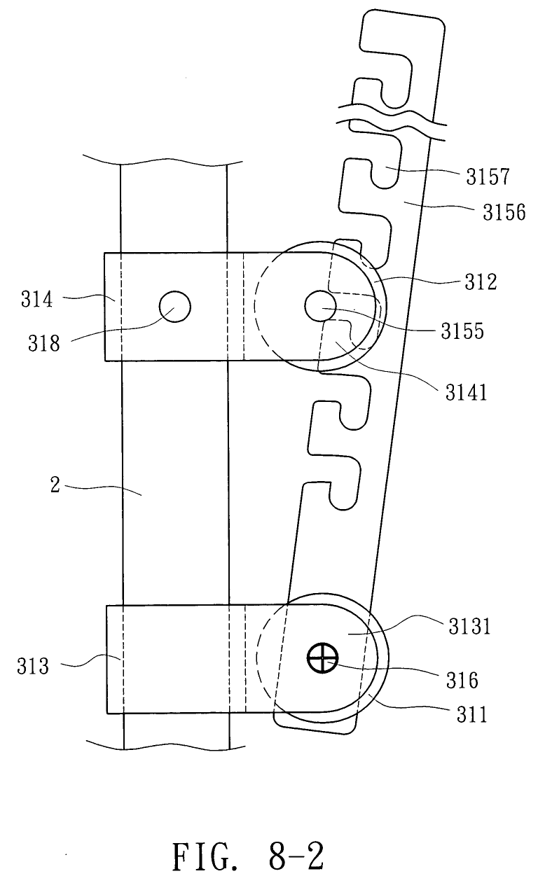

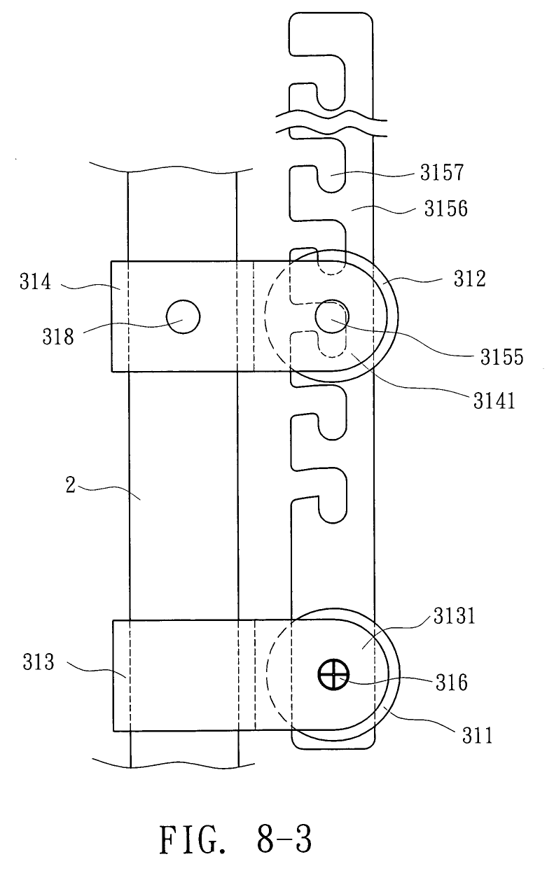

When it is necessary to adjust the shears for shearing branches with different diameters, as shown in FIGS. 8-1 to 8-3, a user can bias the locating bar 3156 with a finger to make the locating bolt 3155 move out of the notch 3157 and separate from the locating bar 3156. At this time, the user can move the locating bar 3156 through a certain distance and then push the locating bar 3156 to make the locating bolt 3155 move into a new notch 3157. Such operation can be also quickly and conveniently performed.

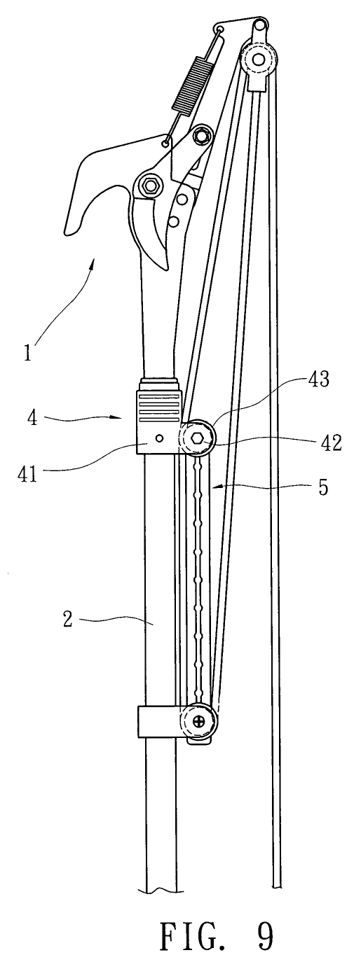

FIG. 9 shows a third embodiment of the present invention, in which the fixed seat 4 has a fitting section 41. The branch shearing mechanism 1 is fitted in one end of the fitting section 41, while the connecting rod 2 is fitted in the other end of the fitting section 41. The fixed seat 4 further has two third lugs 42 protruding from the fitting section 41. A third fixed pulley 43 is pivotally mounted between the third lugs 42. One end of the locating member 5 is positioned between the third lugs 42.

The above embodiments are only used to illustrate the present invention, not intended to limit the scope thereof. Many modifications of the above embodiments can be made without departing from the spirit of the present invention.

What is claimed is:

1. A high-branch shears comprising:
a branch-shearing mechanism connected with one end of a connecting rod for shearing branches; and
a pulley device composed of an adjustment unit, a movable pulley and a cord passed through and wound on the adjustment unit and the movable pulley, the movable pulley being pivotally mounted on a pulley rack which is pivotally connected with the branch-shearing mechanism, the adjustment unit including a first fixed pulley, a movable member, a fixed seat and a locating member, the movable member being slidably fitted on the connecting rod, the first fixed pulley being pivotally mounted on the movable member, the movable member being movable relative to the fixed seat, the fixed seat being fixed on the branch-shearing mechanism or the connecting rod, the locating member being disposed between the movable member and the fixed seat for adjustably fixing a distance between the movable member and the fixed seat, one end of the cord being fixed on the pulley rack, the cord being sequentially passed through and wound on the first fixed pulley and the movable pulley, the other end of the cord being a force application end for a user to pull to drive the branch-shearing mechanism for shearing branches.

2. The high-branch shears as claimed in claim 1, wherein the branch-shearing mechanism includes:
a shear seat connected with the connecting rod, the shear seat having a shear opening facing downward;
a shear board pivotally disposed on the shear seat, the shear board having a blade section corresponding to the shear opening of the shear seat; and
a rocking arm pivotally disposed on the shear seat, one end of the shear board distal from the blade section being pivotally connected with the rocking arm, a restoring spring being connected between the rocking arm and the shear seat, the pulley rack being pivotally connected with one end of the rocking arm distal from the shear seat, when the pulley device drives the rocking arm to swing, the shear board being driven and pivoted, whereby the blade section is moved relative to the shear opening for shearing branches.

3. The high-branch shears as claimed in claim 1, wherein the movable member is a substantially ring-shaped member fitted around the connecting rod, the movable member having two first lugs, a pin member being connected between the first lugs, the first fixed pulley being pivoted on the pin member, one end of the locating member being fixed with the pin member, the fixed seat being a substantially ring-shaped member fixedly fitted around the connecting rod near the branch-shearing mechanism, the fixed seat having two second lugs, a second fixed pulley being pivotally disposed between the second lugs, the other end of the locating member being positioned between the second lugs.

4. The high-branch shears as claimed in claim 3, wherein the locating member includes a locating bolt and a locating bar, the locating bolt having a small diameter section and a large diameter section, the locating bolt being fitted through the second lugs, a first end of the locating bolt outward protruding from one of the second lugs, a resilient member being disposed between the first end of the locating bolt and the second lug adjacent to the first end of the locating bolt, the small diameter section of the locating bolt extending from the first end of the locating bolt to one side of the locating bar proximal to the resilient member, the large diameter section extending from the small diameter section a second end of the locating bolt, the locating bar being formed with a slot for the small diameter section of the locating bolt to extend through, the slot having several locating holes for the large diameter section of the locating bolt to pass therethrough, whereby the large diameter section can extend through any of the locating holes of the locating bar.

5. The high-branch shears as claimed in claim 4, wherein the resilient member is a compression spring.

6. The high-branch shears as claimed in claim 1, wherein a fixing pin is radially passed through the fixed seat and the connecting rod to fix the fixed seat on the connecting rod.

7. The high-branch shears as claimed in claim 3, wherein the locating member includes a locating bolt and a locating bar, one side of the locating bar being formed with several substantially L-shaped notches facing the connecting rod, whereby the locating bolt can be inlaid and located in any of the notches.

8. The high-branch shears as claimed in claim 1, wherein the fixed seat has a fitting section, the branch shearing mechanism being fitted in one end of the fitting section, while the connecting rod being fitted in the other end of the fitting section, the fixed seat further having two third lugs protruding from the fitting section, a third fixed pulley being pivotally mounted between the third lugs, one end of the locating member being positioned between the third lugs.
